(19) United States
(12) Patent Application Publication
(10) Pub. No.: US 2011/0161928 A1
(43) Pub. Date: Jun. 30, 2011

(54) Method to Provide Transparent Process I/O Context on a Remote OS While Retaining Local Processing

(75) Inventors: Sudhir Sangra, Maharashtra (IN); Geert De Peuter, Turnhout (BE)

(73) Assignee: BMC Software, Inc., Houston, TX (US)

(21) Appl. No.: 12/750,370

(22) Filed: Mar. 30, 2010

Related U.S. Application Data
(60) Provisional application No. 61/291,505, filed on Dec. 31, 2009.

(51) Int. Cl. G06F 9/44

(52) U.S. Cl. 717/115

(57) ABSTRACT

Systems and methods are disclosed that implement a data collection infrastructure that supports both agent-based and agentless data collection. Existing data collection scripts may be used, whether agent-based or agentless, and new scripts may be created that include commands that may execute either locally or remotely, as desired. These scripts, while executed locally, may interact with either the local machine or another remote machine for performing data collection, corrective actions, or other desired functionality. An execution context defines whether commands executed by the script are to execute locally or remotely, and a context handler allows processing those commands either locally or remotely depending on the execution context, transparently to the script. Data generated by remote execution may be transported back to the local machine for manipulation locally, transparently to the script.

### CROSS REFERENCE TO RELATED APPLICATIONS

This Application claims priority to U.S. Provisional Application Ser. No. 61/291,505 entitled “Method to Provide Transparent Process I/O Context on a Remote OS While Retaining Local Processing” filed Dec. 31, 2009, which is incorporated by reference in its entirety herein.

### BACKGROUND

This disclosure relates generally to the field of computer programming. More particularly, but not by way of limitation, it relates to a technique for improving data collection for systems management.

As networks and the Internet in particular have continued to grow in size, so have datacenters that house servers and provide software applications to users across such networks. With servers and software applications numbering in the thousands, a large diversity of server and application types, and significant numbers of configuration elements associated with each server and application, managing both hardware and software resources within datacenters has become challenging. To complicate matters further, these resources frequently are not statically configured, but are instead reconfigured on an as-needed basis, depending upon user demand and resource capacity.

In order to monitor, control, and manage such large and dynamic systems, a significant amount of data must be collected system-wide and processed by one or more system management stations. Many different solutions have developed over time for optimally collecting such data, including both agent-based and agentless solutions. Agent-based solutions generally include programs or scripts that are distributed to and executed on the various nodes monitored by the system management station(s). Because they are distributed throughout the system, agents provide for very scalable data collection and may provide local evaluation and storage of collected data, and actions that are based upon the behavior of the data. However, because agents must be configured and installed or loaded on the monitored node, significant overhead is incurred in managing the agents for large systems, which may have thousands of nodes that each requires a data collection agent.

Agentless data collection solutions were developed to overcome some of the deficiencies of agent-based solutions. Several different agentless approaches have resulted. Some examples include:
A combination of server-side and client-side scripts, wherein the scripts are (temporarily) transferred to a monitored node.
Agents that are distributed “on-the-fly” for local execution on a monitored client node.
Server-side scripts that include client-side-specific code that is remotely executed on a monitored client node (e.g., using ssh).

While both agent-based and agentless data collection solutions can use scripts, the scripts used by an agent-based solution are significantly different from the scripts used by an agentless solution. These differences can make transitioning from one approach to the other, or supporting both approaches within a single system, challenging.

### SUMMARY

In one embodiment, a method is disclosed. The method comprises supplying an execution context to a context handler; intercepting by the context handler a request for a first functionality from a first program, executing on a first device; and initiating execution of the first functionality by the context handler on the first device or a second device, depending on the execution context, transparently to the first program.

In another embodiment, a non-transitory computer readable medium is disclosed. The non-transitory computer readable medium has instructions for a programmable control device stored thereon wherein the instructions cause a programmable control device to perform the method described above.

In yet another embodiment, a networked computer system is disclosed. The networked computer system comprises a plurality of computers communicatively coupled, at least one of the plurality of computers programmed to perform at least a portion of the method described above wherein the entire method described above is performed collectively by the plurality of computers.

In yet another embodiment, a method is disclosed. The method comprises supplying an execution context to a context handler; intercepting by the context handler a request for a first functionality from a first program, executing on a first device; and executing the first functionality on the first device or a second device, responsive to the execution context, transparently to the first program, comprising: executing the first functionality on the first device if the execution context indicates a local execution context; and executing the first functionality on the second device if the execution context indicates a remote execution context, comprising: establishing a connection to the second device; and executing the first functionality on the second device through the connection.

### BRIEF DESCRIPTION OF THE DRAWINGS

FIG. 1 illustrates, in flowchart form, an example of a technique for transparently processing a script locally or remotely according to one embodiment.

FIG. 2 illustrates, in block diagram form, an example of executing certain functionality of a single script either locally or remotely depending on an execution context according to one embodiment.

FIG. 3 illustrates, in block diagram form, another example of executing certain functionality of a single script either locally or remotely depending on an execution context according to one embodiment.

FIG. 4 illustrates, in block diagram form, yet another example of executing certain functionality of a single script either locally or remotely depending on an execution context according to one embodiment.

FIG. 5 illustrates, in block diagram form, an example of a computing device for providing an execution context to allow execution of certain functionality of a script either locally or remotely depending on the execution context according to one embodiment.

FIG. 6 illustrates, in block diagram form, an exemplary network of computers in which certain functionality of scripts may execute locally or remotely depending on an execution context.

### DETAILED DESCRIPTION

The following description is written in terms of scripts, which are usually understood as programs written in a language that is interpreted by an interpreter, instead of compiled by a compiler into executable code. The present invention is not limited to interpreted scripts, however, and the techniques described herein may be used both with interpreted and compiled programs written in any desired or convenient programming language.

By providing an environment that understands the desired execution context, scripts may be written that allow certain functionality to run either remotely or locally without changes to the script. Functionality invoked by the script is processed by the environment depending on a desired execution context, transparently to the script. This allows script writers to focus on the desired functionality without needing to consider whether the functionality will execute locally or remotely. When executing remotely, the environment allows the script to perform the desired activity without preinstallation of the script on the remote node or including code in the script to transport the script to the remote node for execution, and without having to write code in the script to transport the collected data from the remote node to the local node.

Although some embodiments of the techniques disclosed herein may be used by performance management systems to monitor local and remote nodes, the techniques disclosed herein are not limited to scripts that perform monitoring of nodes or data collection in such a system, but may be used in any system in which it is desired to execute scripts that may execute certain functionality on either a local or a remote system, transparently to the script.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

The disclosure below describes systems and methods that implement an infrastructure that supports both agent-based and agentless data collection and other desired functionality. Existing scripts may be used, whether agent-based or agentless, and new scripts may be created that include commands that may execute either locally or remotely, as desired. Such “hybrid” scripts, while executed locally, may interact with either the local machine or another remote machine for performing data collection, corrective actions, or other desired functionality. An execution context defines whether commands executed by the script are to execute locally or remotely, and a context handler software provided by the execution environment allows processing those commands either locally or remotely depending on the execution context, transparently to the script. Data generated by remote execution may be transported back to the local machine for manipulation locally, transparently to the script. Further, local execution of the script on a management station, for example, enables “close to the node” historical storage and data evaluation.

Various embodiments may be implemented in computer hardware, software, or a combination of hardware and software. In one embodiment, the script execution infrastructure that provides the execution context and the context handler may be implemented in a virtual machine, which allows modifying the compilers or interpreters in the virtual machine environment of a virtual machine operating system, transparent to a host operating system or hypervisor.

The script execution infrastructure and local and remote nodes of the IT infrastructure provide an execution context to the script that configures the interaction of the script with the underlying operating system or input/output (I/O) subsystem. This allows the script to run unmodified on either a local or a remote node, while processing the output of the script locally. The execution context may be identified as either “local” or “remote,” depending on whether the data collection or other functionality requested by the script will occur on the node executing the script or on another node of the IT infrastructure, such as a node from which data is to be collected. The specific form of the identification is not significant and any desired technique for identifying the execution context may be used.

The execution environment provides a context handler that handles interactions between the script and a certain kinds of environmental functionality, including interactions with the operating system, files, and other types of I/O. If the interaction is to be performed locally, the context handler causes the functionality to be performed by the local system, for example by reading a file from a local file system. If the execution context is identified as a remote context, then the functionality is performed on the remote system. Any convenient or desired technique for remote execution known to the art may be used. In one embodiment, the underlying operating system provides a secure shell (ssh) capability that may be used to execute a process on a remote system, returning data to the local system over the ssh connection. The ssh protocol allows for remote execution using public key encryption certificates instead of providing passwords. Upon completion of the ssh session, the context handler may return the data to the script as if the data was collected locally. Other examples of remote execution methods are SNMP, telnet, WMI, rexec, rstat. Each of these methods may require specific authentication, which may be abstracted by methods known in the art like impersonation or account aliases, to make management of these credentials easier. We define the “execution channel” as the combination of the remote connection method and the required attributes to establish the connection, regardless of the underlying technology that is used and the organization of those attributes. Once the interaction with the context handler to perform the functionality has completed, the script may continue to execute locally.

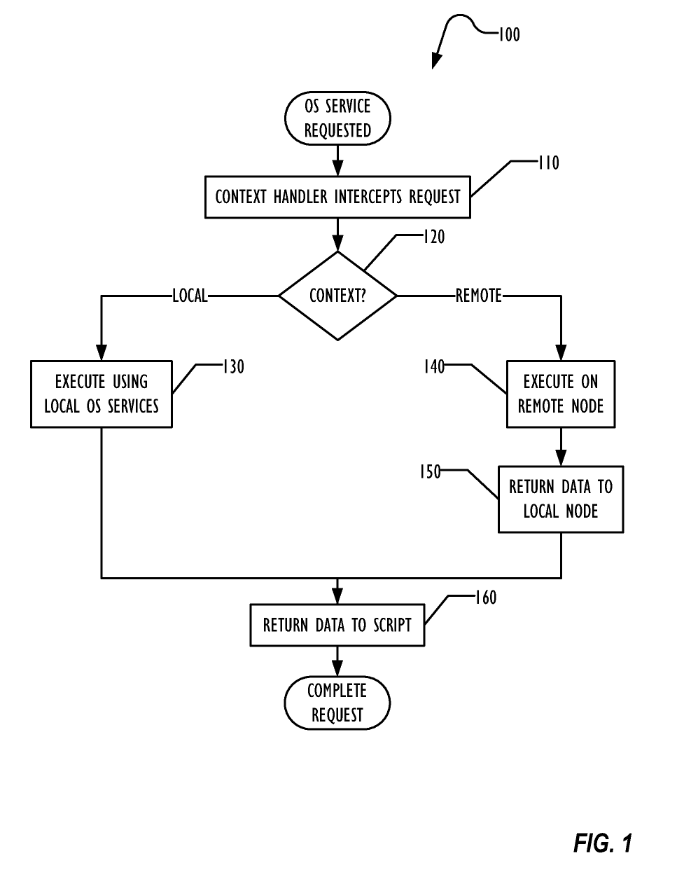

FIG. 1 is a flowchart illustrating a basic technique 100 for using an execution context to allow execution of operating system service remotely or locally depending on the execution context. The context handler may intercept the request for an OS-provided service in block 110 as described in more detail below. In block 120, the context handler may decide whether the execution context indicates the request should be performed locally or remotely. If locally, then in block 130, the context handler may forward the request on to the appropriate OS service on the local machine. If remotely, then in block 140, the context handler may cause the request to be performed on the designated remote node. If necessary, the context handler may push data or executable code temporarily to the remote node. In block 150, the data generated by that request (if any) may be returned from the remote node to the local node. Then in block 160, the data (if any) generated by the request, whether generated locally or remotely, is passed back to the calling script for use by the script, and the request completes.

The execution context may also provide context for other system management functions other than data collection in some embodiments. For example, in one embodiment, events may be generated locally by the controlling agent, such that the events appear as if they occurred on the remote machine. The execution context and context handler operate to provide the correct (remote) event origin even though the local node's event infrastructure generates the actual event.

In at least some embodiments, an object model may be implemented wherein scripts may be executed in the context of an instance of a class or other object. Execution context attributes may be defined for the instance, and scripts that execute in the context of the instance may inherit the attributes set on that object instance. Such attributes may also be used to set the correct origin of generated events, as previously described. In addition to this, the object model can provide inheritance in such a way that child instances can transparently inherit execution context from a parent in the hierarchy.

Although referred to herein as a “context handler,” embodiments may implement the functionality to cause execution remotely or locally in ways that do not necessarily require a separate module or program, but may provide the context handling capability as part of other modules or programs. The context handling functionality may be bundled in with other functionality of the OS, a virtual machine, an interpreter, a compiler, or a runtime library of routines to perform the interception and processing of calls for service requests from the script according to the execution context.

The script does not need to assume that any specific functionality exists on either the local node or any remote node. In one embodiment, the context handler may choose to execute certain commands remotely This allows the context handler to be aware of the capabilities of the remote node, and push execution of functionality to the remote node if the remote node supports the execution of the functionality

In another embodiment, the execution context may specify whether execution is to occur remotely, without specifying the remote node on which execution should occur. This may allow the context handler to use knowledge of the infrastructure and select the remote node on which to execute the functionality, transparently to the script, using any desired technique for selecting the remote node. Likewise the execution context may decide to use a specific execution method depending on the actual command or complexity of the remote execution that is required to satisfy the caller.

In one embodiment, the context handler may not push execution of functionality to a remote node if that functionality requires resources that are unavailable to the remote node. However, the context handler in some embodiments may be able to perform a complex set of processing operations as part of the processing of a command in the script, such that the context handler may create the needed resources on the remote node before causing the functionality designated by the command to execute on that remote node.

In one embodiment, only certain types of functionality provided by the script may be processed by the context handler based on the execution context. For example, while the context handler may handle a command to execute an external program, the context handler may not handle a simple assignment statement that increments a variable by a constant. The extent to which the context handler processes script functionality may vary from embodiment to embodiment as desired, and may also depend on the execution context.

In some embodiments, the support provided by the context handler may be provided by implementing a “wrapper” program. A wrapper program typically is a program that is called with the same name as the actual command or program that the user desires to execute, allowing the call to be intercepted to replace the original program or to allow for other functionality could be performed in addition to or instead of the original program. Using a wrapper may allow more complex operations to be executed, depending on the execution context, than simple commands. The script, however, may be unaware of the existence of the wrapper program, which executes transparently to the script.

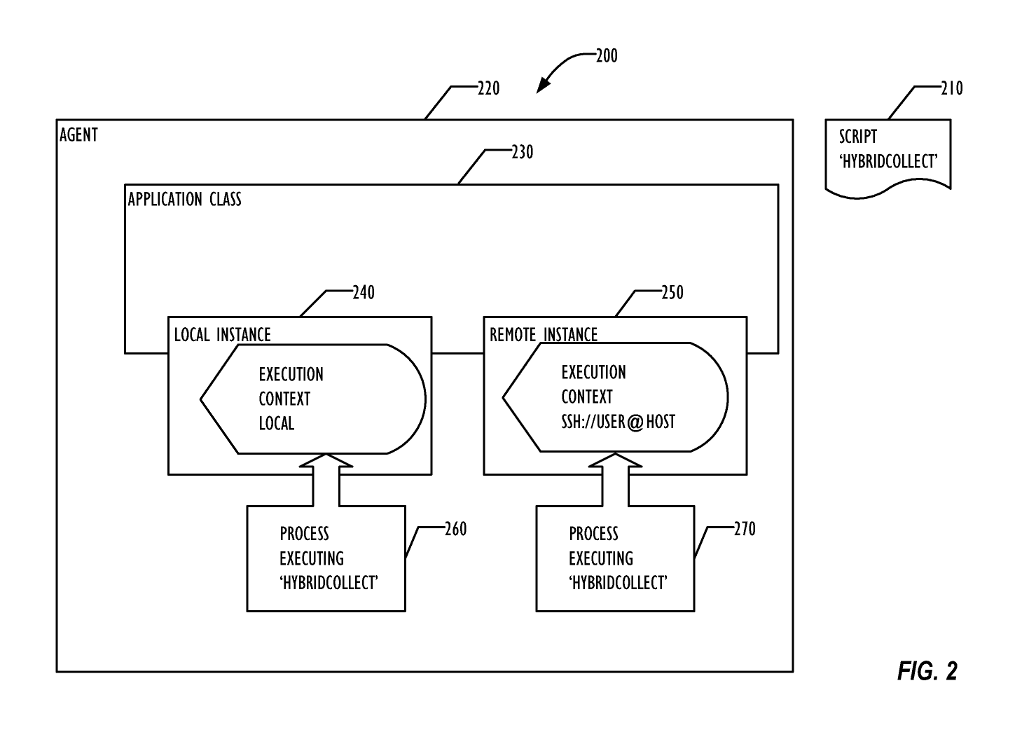

An example embodiment is illustrated in FIG. 2, where a data collection script named “HYBRIDCOLLECT” is executed.

An example of the HYBRIDCOLLECT script 210 may be as follows:

processes = process(“*”);
foreach proc (processes) {
pname = ntharg(proc,1);
pcpu = ntharg(proc, 5);
create(pname,pname,OK,“”,“.”);
set(pname.“/CPUUtil/value”, pcpu);
}

In this example, the process( ) command requires interaction with the OS to obtain information about each process executing under the control of the OS. In the example illustrated by FIG. 2, the script 210 may be executed by instances of an application class 230 of an agent 220. Local instance 240 may execute the script 210 in process 260, creating a context identified as local. In that context, the HYBRIDCOLLECT script process( ) command may obtain the process information from the local OS. The same script 210, running in process 270 in the remote instance context 250, may request the process information from the remote node identified to the remote instance 250. In one embodiment, the process( ) command may be executed remotely using a remote execution channel to send a command to the remote node and retrieve the data, executing on node “host” by user “user,” as specified by the execution context. Both the local instance 240 and the remote instance 250 may be created locally and for both instances, data may be saved locally, and evaluation of the data, such as evaluating whether a management metric has crossed a threshold value for that metric, may be performed locally. Thus, parts of the script that do not require interaction with the remote OS may be performed locally, even in an execution context specifying remote execution.

In the example script 210 set forth above, the lines of the script following the process( ) command, which examine the process data captured for all processes running on the local or remote node, depending on whether the script 210 runs in process 260 or process 270, are executed locally, extracting the process name and the CPU from the process data returned by the process( ) command and creating new data in the local node.

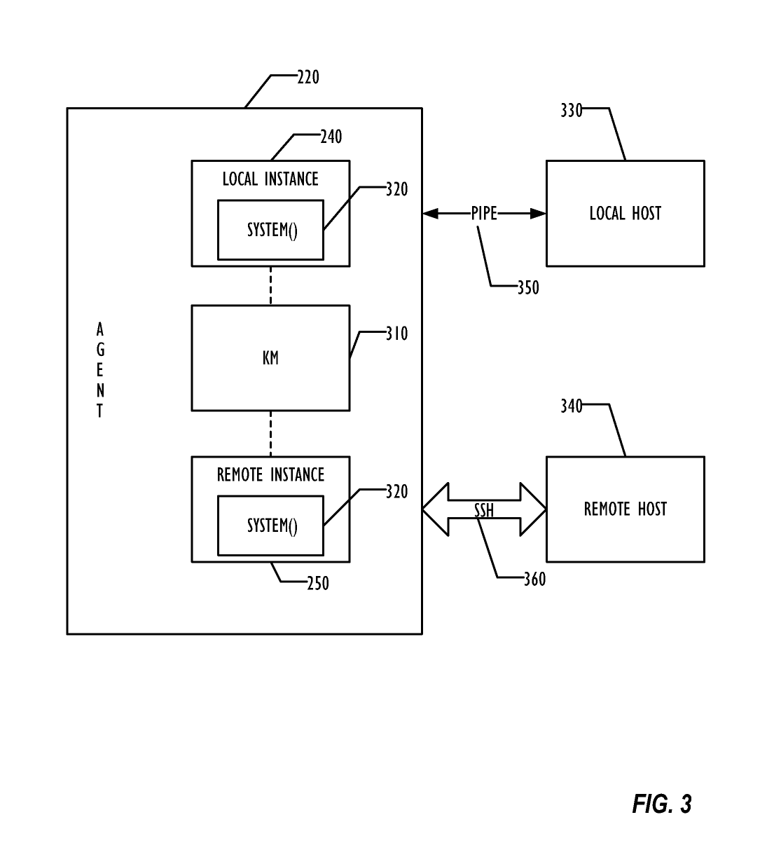

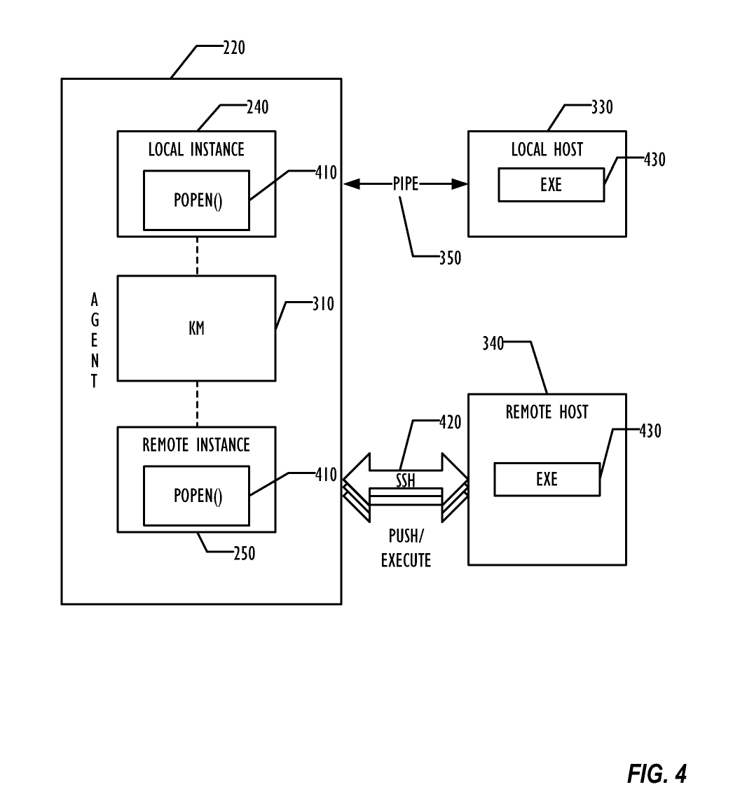

In one embodiment, illustrated in FIG. 3 and FIG. 4, the agent 220 operates as part of a performance management system environment in which scripts are associated with parameters within a knowledge module 310. Each instance of the knowledge module 310 may inherit the same executable code but have a private copy of global data, and may have a private property or data unique to that instance. In one embodiment, the execution context may be a private property of the knowledge module 310.

In other embodiments, context information may be implemented in a JAVA® environment (JAVA is a registered trademark of Sun Microsystems, Inc.), using any of a variety of known techniques for providing private data to an instance of an object, or by extending the core Java Virtual Machine (JVM). In yet other embodiments, the execution context may be provided to an interpreter for the scripting language by a command line parameter or an environment variable. In yet other embodiments using compiled programming languages, techniques such as import address table patching, library overriding, or a modified runtime library package may be used to provide the execution context to the compiled program and to allow the context handler to cause the compiled program to behave differently depending on the execution context.

In FIG. 3, the script 320 may be executed in either remote instance 250 or local instance 240 according to one embodiment. The agent 220 loads a knowledge module 310 that may make the execution context available to the instances 240 and 250 during instance creation

The script 320 in this example includes a statement or function call that may be used to execute a command, such as an OS command or another program. The executed command terminates after execution, possibly returning output. In FIG. 3, this is illustrated as a system( ) call; in other environments or scripting languages, this functionality may be referred to as an execute( ) or call( ) statement, for example.

When executing in the remote instance 250 in one embodiment, the context handler provided by the agent 220 may process the system( ) command by directly executing the indicated command or program. In some embodiments, this may be performed by creating a named pipe 350 that allows returning the output from the executed command or program to the calling program.

In the remote instance 250, the execution context may identify not only the remote host to be used for executing the command or program and user authentication data, but also the technique used for accomplishing the remote execution. In one embodiment, secure shell (ssh) 360 functionality provided by the OS or the environment 220 is used to send a command or program to the remote host 340, execute it and return any output 360. Any technique known to the art as “remote execution channel” may be used by the context handler for this purpose.

In one embodiment, the execution context specifying remote execution may specify the remote node name, user authentication data, such as a userid and password or certificate, and a protocol for connecting to the remote node, which may include any desired protocol, including proprietary transport protocols.

FIG. 4 is a block diagram illustrating another script 410 executed according to one embodiment. In this example, the script 410 may execute a command or program that initiates a process then terminates, with the initiated process continuing to run after the initiator terminates. In the example of FIG. 4, the script 410 executes a popen( ) command that in one embodiment may open a pipe to an external process that allows asynchronous or synchronous reads or writes to the external process. In this example, the pipe may remain open after the popen( ) command terminates, and the disclosed techniques may support commands or programs that close the pipe after completion. The popen( ) command allows the script to push an executable that may then execute, processing data and returning data to the script, possibly multiple times over an extended period. Depending on the execution context, the executable may be executed on either the local node or the remote node specified by the execution context, transparently to the script. In the remote execution context illustrated in FIG. 4, executable 430 may be pushed to the remote node 340 via an execution channel 420. In the local execution context, the executable 430 may be executed on the local node 330 via the named pipe 350. In one embodiment, this could mean that the executable that is pushed to the remote node provides agent-like functionality by itself.

The system( ), execute( ), and popen( ) commands are illustrative and by way example only, and any commands supported by the OS and the programming language used to write the scripts 320 or 410 may be used to execute either remotely or locally, including any operation that interacts with the local OS, such as reading from or writing to a file.

By providing a context that defines how and where a command within a script is executed, scripts may be written as if they are to be executed on a local node, even though the data may be collected by the script from a remote node. In addition, as previously explained, existing scripts may be executed with little or no modifications. This is because the context sensitivity of operating system and input/output operations may be implemented in the infrastructure and is transparent to the scripts. Such transparency thus provides the ability to migrate an agent-based system to an agentless-based system at little or no extra cost and without the need to change the underlying technology of the data collection system. In some embodiments, the script may be able to determine whether the execution context specifies local or remote execution. In other embodiments, the script cannot determine anything about the execution context.

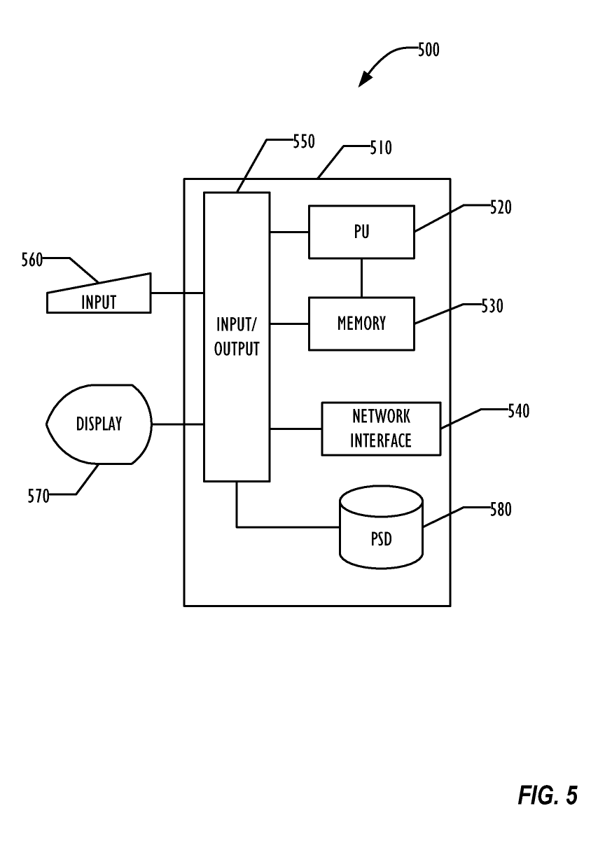

Referring now to FIG. 5, an example computer 500 for use in providing a transparent process context is illustrated in block diagram form. Example computer 500 comprises a system unit 510 which may be optionally connected to an input device or system 560 (e.g., keyboard, mouse, touch screen, etc.) and display 570. A program storage device (PSD) 580 (sometimes referred to as a hard disc) is included with the system unit 510. Also included with system unit 510 is a network interface 540 for communication via a network with other computing and corporate infrastructure devices (not shown). Network interface 540 may be included within system unit 510 or be external to system unit 510. In either case, system unit 510 will be communicatively coupled to network interface 540. Program storage device 580 represents any form of non-volatile storage including, but not limited to, all forms of optical and magnetic, including solid-state, storage elements, including removable media, and may be included within system unit 510 or be external to system unit 510. Program storage device 580 may be used for storage of software to control system unit 510, data for use by the computer 500, or both.

System unit 510 may be programmed to perform methods in accordance with this disclosure (an example of which is in FIG. 1). System unit 510 comprises a processor unit (PU) 520, input-output (I/O) interface 550 and memory 530. Processing unit 520 may include any programmable controller device including, for example, one or more members of the Intel Atom®, Core®, Pentium® and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Memory 530 may include one or more memory modules and comprise random access memory (RAM), read only memory (ROM), programmable read only memory (PROM), programmable read-write memory, and solid-state memory. One of ordinary skill in the art will also recognize that PU 520 may also include some internal memory including, for example, cache memory.

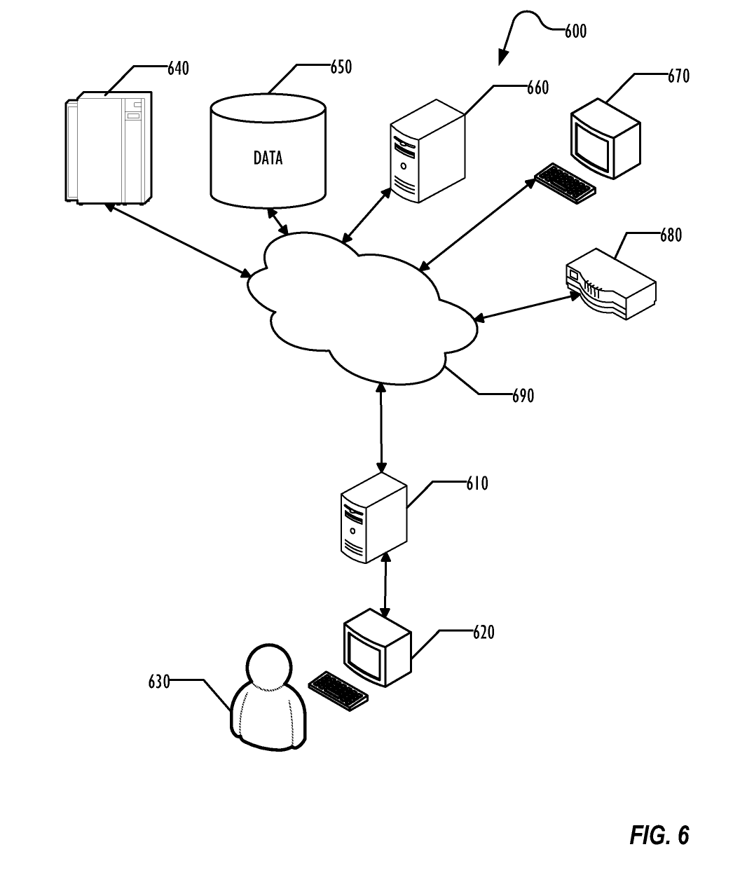

FIG. 6 is a block diagram illustrating an IT infrastructure 600 in which the techniques described above may be implemented according to one embodiment. A performance management server 610 may execute performance management scripts to collect data from any of the example infrastructure elements 640-680, which as illustrated may include a mainframe 640, a data storage system 650, a server 660, a workstation 670, and a router 680, and software elements (not shown in FIG. 6 for clarity) that execute on those devices. The elements shown in FIG. 6 are illustrative and by way of example only, and other hardware and software elements may be monitored by the performance management server 610 as desired using scripts that execute either locally on the performance management server 610 or remotely on one of the IT infrastructure elements 640-680. As illustrated in FIG. 6, the elements of the IT infrastructure 600 are connected to each other and to the performance management server 610 by network 690, which may be any type of network known to the art. Alternatively, any of the elements of the IT infrastructure 600 may be directly connected to any other of the elements of the IT infrastructure 600 or to the performance management server 610 as desired, using any desired technique for connecting two devices.

In addition, an operator 630 in one embodiment may interact with the performance management server 610 by using an operator console or management workstation 620, issuing commands and taking actions as desired in response to data or events generated by the scripts executing on the performance management server 610. In other embodiments, the functions of the operator workstation 620 may be subsumed into the performance management server 610.

As indicated above, the performance management system 600 of FIG. 6 is an illustrative example of a networked computer system that may embody the techniques described above. Other networked computer systems may embody those techniques for purposes other than performance management as desired.

Various changes in the components as well as in the details of the illustrated operational method are possible without departing from the scope of the following claims. For instance, the illustrative system of FIG. 5 may be comprised of more than one computer communicatively coupled via a communication network, wherein the computers may be mainframe computers, minicomputers, workstations or any combination of these. Such a network may be composed of one or more local area networks, one or more wide area networks, or a combination of local and wide-area networks. In addition, the networks may employ any desired communication protocol and further may be “wired” or “wireless.” In addition, acts in accordance with FIG. 1 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method, comprising:
supplying an execution context to a context handler;
intercepting by the context handler a request for a first functionality from a first program, executing on a first device; and
initiating execution of the first functionality by the context handler on the first device or a second device, depending on the execution context, transparently to the first program.

2. The method of claim 1, further comprising:
providing data generated by the execution of the first functionality from the context handler to the first program.

3. The method of claim 1, wherein the act of supplying an execution context comprises:
specifying a technique to be used by the context handler to perform the act of executing the first functionality on the second device.

4. The method of claim 1, wherein the act of supplying an execution context comprises:
specifying the second device.

5. The method of claim 1, wherein the act of supplying an execution context comprises:
specifying a user authentication data to be used by the context handler to perform the act of executing the first functionality on the second device.

6. The method of claim 1, wherein the act of initiating execution of the first functionality by the context handler comprises:
establishing a connection to the second device responsive to the execution context;
pushing data corresponding to the first functionality to the second device; and
executing the first functionality on the second device.

7. The method of claim 1, wherein the act of initiating execution of the first functionality by the context handler the comprises:
executing the first functionality on the first device responsive to the execution context.

8. The method of claim 1, wherein the act of supplying an execution context comprises:
instructing the context handler to perform the act of initiating execution of the first functionality requested by the first program on a device other than the first device.

9. The method of claim 1, wherein the act of intercepting comprises:
providing a wrapper for the first functionality requested by the program.

10. The method of claim 1, wherein the act of intercepting comprises:
modifying an interpreter for a scripting language to pass execution of a first scripting language feature corresponding to the first functionality to the context handler.

11. The method of claim 1, wherein the act of intercepting comprises:
modifying a runtime library used by the program to pass the request for the first functionality from the program to the context handler.

12. The method of claim 1, wherein the act of supplying an execution context comprises:
establishing an instance of an execution environment for the program, comprising the context handler;
passing a parameter to the execution environment, wherein the parameter specifies the execution context; and
providing the parameter to the context handler.

13. The method of claim 1, further comprising:
creating by the context handler a resource used by the first functionality on the first device or the second device, depending on the execution context.

14. A non-transitory computer readable medium with instructions for a programmable control device stored thereon wherein the instructions cause a programmable control device to perform the method of claim 1.

15. A networked computer system comprising:
a plurality of computers communicatively coupled, at least one of the plurality of computers programmed to perform at least a portion of the method of claim 1 wherein the entire method of claim 1 is performed collectively by the plurality of computers.

16. A method, comprising:
supplying an execution context to a context handler;
intercepting by the context handler a request for a first functionality from a first program, executing on a first device; and
executing the first functionality on the first device or a second device, responsive to the execution context, transparently to the first program, comprising:
executing the first functionality on the first device if the execution context indicates a local execution context; and
executing the first functionality on the second device if the execution context indicates a remote execution context, comprising:
establishing a connection to the second device; and
executing the first functionality on the second device through the connection.

17. The method of claim 16, wherein the act of supplying an execution context comprises:
identifying the second device and a technique for performing the act of executing the first functionality on the second device.

18. The method of claim 16, wherein the act of executing the first functionality on the first device or a second device comprises:
returning data output by the act of executing the first functionality to the context handler; and
returning the data from the context handler to the program.

19. The method of claim 16, wherein the act of establishing a connection to the second device comprises:
pushing an executable for the first functionality to the second device.

20. The method of claim 16, wherein the act of executing the first functionality on the second device further comprises:
terminating the context handler prior to completing the act of executing the first functionality on the second device.
